(19) United States
(12) Patent Application Publication
(10) Pub. No.: US 2025/0221480 A1
(43) Pub. Date: Jul. 10, 2025

(54) GARMENT AND QUALITY INDICATION MEMBER

(71) Applicant: HONESTIES INC., Osaka (JP)

(72) Inventor: Kiyohiko NISHIDE, Osaka (JP)

(21) Appl. No.: 19/091,770

(22) Filed: Mar. 26, 2025

Related U.S. Application Data
(63) Continuation of application No. PCT/JP2023/033774, filed on Sep. 15, 2023.

(30) Foreign Application Priority Data
Sep. 27, 2022 (JP) 2022-154006

(51) Int. Cl. A41D 27/08

(52) U.S. Cl. CPC A41D 27/08

(57) ABSTRACT

A garment having a first face and a second face on an opposite side of the first face comprises: a quality display portion that displays quality information related to quality of the garment and is provided on the second face; and a display cover portion that displays information (identification information) other than the quality information and is provided to cover the quality display portion. At least one of the quality display portion and the display cover portion is deformable so as to be able to transition between a covered state in which the quality display portion is covered by the display cover portion and an exposed state in which at least a part of the quality display portion is exposed.

### CROSS-REFERENCE TO RELATED APPLICATIONS

The present application is a U.S. National Stage entry of PCT Application number PCT/JP2023/33774, filed on Sep. 15, 2023, which claims priority under 35 U.S.C § 119 (a) to Japanese Patent Application No. 2022-154006, filed on Sep. 27, 2022, contents of which are incorporated herein by reference in their entirety.

### BACKGROUND OF THE INVENTION

The present disclosure relates to a garment and a quality indication member.

In recent years, highly convenient garments have been proposed. For example, Japanese Unexamined Patent Application Publication No. H10-273807 discloses a garment configured to be worn in the same manner in both its normal and reversed states, with the reversed state being obtained by turning the garment inside out.

Garments are required to have quality labeling due to legal requirements (such as the Household Goods Quality Labeling Act), and a quality indication tag (hereinafter also referred to as a quality labeling tag) is sewn onto a garment, for example. However, quality labeling provided by a quality indication tag sewn onto a garment often compromises the aesthetic design of the garment.

### BRIEF SUMMARY OF THE INVENTION

The present disclosure focuses on this point, and an object thereof is to provide quality labeling for garments and other articles without compromising their aesthetic design.

A first aspect of the present disclosure provides a garment having a first surface and a second surface opposite the first surface, including a quality indication part that indicates quality information on quality of the garment and is provided on the second surface, and an indication covering part that indicates information other than the quality information and is provided so as to cover the quality indication part, wherein at least one of the quality indication part or the indication covering part is deformable so that transition between a first state in which the quality indication part is hidden by the indication covering part and a second state in which at least a portion of the quality indication part is exposed is available.

A second aspect of the present disclosure provides a quality indication member provided to an article having a first surface and a second surface opposite the first surface, including a quality indication part that indicates quality information on quality of the article and is provided on the second surface, and an indication covering part that indicates information other than the quality information and is provided so as to cover the quality indication part, wherein at least one of the quality indication part or the indication covering part is deformable so that transition between a first state in which the quality indication part is hidden by the indication covering part and a second state in which at least a portion of the quality indication part is exposed is available.

### BRIEF DESCRIPTION OF THE DRAWINGS

FIG. 1 is a schematic diagram for explaining a configuration of a reversible garment 1 according to an embodiment.

FIG. 2 is a schematic diagram showing the reversible garment 1 in a turned-inside-out state.

FIG. 3A is an enlarged schematic view of a portion A in FIG. 2.

FIG. 3B is an enlarged schematic view of the portion A in FIG. 2.

FIG. 4A is a schematic diagram for explaining a quality indication part 120 and an indication covering part 130 according to a first modified example.

FIG. 4B is a schematic diagram for explaining the quality indication part 120 and the indication covering part 130 according to the first modified example.

FIG. 5A is a schematic diagram for explaining a quality indication part 220 and an indication covering part 230 according to a second modified example.

FIG. 5B is a schematic diagram for explaining the quality indication part 220 and the indication covering part 230 according to the second modified example.

FIG. 6A is a schematic diagram for explaining a modified example of a reversible garment 2.

FIG. 6B is a schematic diagram for explaining the modified example of the reversible garment 2.

FIG. 7A is a schematic diagram for explaining a quality indication part 320 and an indication covering part 330 according to a third modified example.

FIG. 7B is a schematic diagram for explaining the quality indication part 320 and the indication covering part 330 according to the third modified example.

FIG. 7C is a schematic diagram for explaining the quality indication part 320 and the indication covering part 330 according to the third modified example.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Configuration of Garment

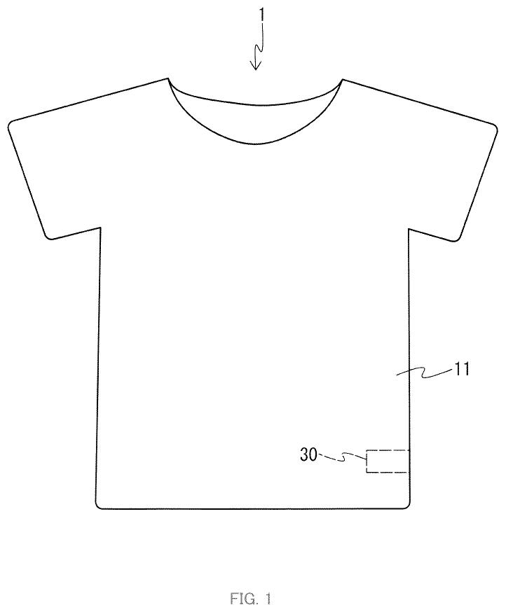

A configuration of a garment according to an embodiment of the present disclosure will be described with reference to FIGS. 1, 2, 3A and 3B. In the following, a reversible garment will be described as an example of the garment. A reversible garment is a garment configured to allow both a first surface and a second surface to be used, and “use” refers to “wear” in general, and “both to be used” means that the garment is configured to be worn with either the first surface or the second surface facing inward (or outward). That is, a reversible garment is a garment designed to be worn with either the first surface or the second surface facing inward (or outward) without any problem in terms of aesthetic design, comfort, or other factors, and such a usage mode is intended as part of the product design.

In the following description, a reversible shirt is provided as an example of the garment, but it is not limited thereto. For example, the garment according to the present disclosure may include pants, trousers, sweat shirts, socks, fabric rolls, traditional Japanese garments, hats, and the like. It should be noted that, although the garment according to the present disclosure has been described as a reversible garment, it is not limited thereto, and for example, the garment according to the present disclosure may be a garment designed to be worn with only one of the first surface and the second surface (in this case, the first surface) facing outward (in other words, a non-reversible garment).

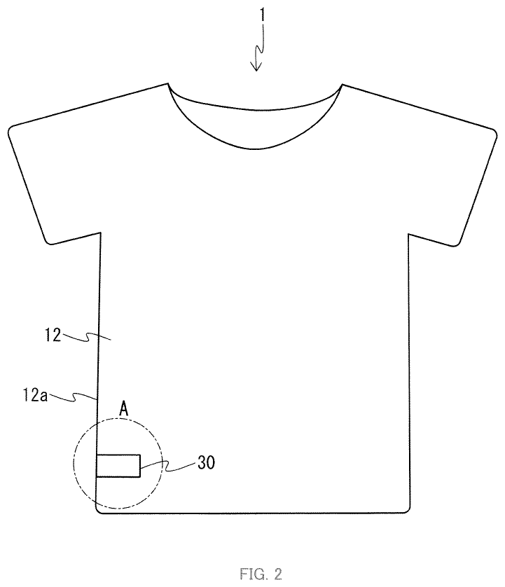

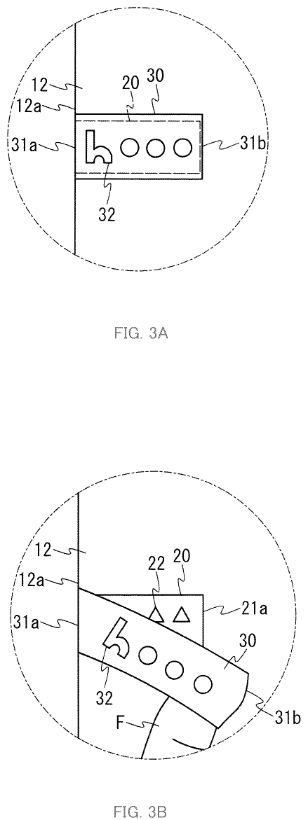

FIG. 1 is a schematic diagram for explaining a configuration of a reversible garment 1 according to an embodiment. FIG. 2 is a schematic diagram showing the reversible garment 1 in a turned-inside-out state. FIGS. 3A and 3B are enlarged schematic views of a portion A in FIG. 2. It should be noted that FIG. 3A shows a covered state in which a quality indication part 20 is covered by an indication covering part 30, and FIG. 3B shows an exposed state in which at least a portion of the quality indication part 20 is exposed. In the present embodiment, the covered state corresponds to a first state in which the quality indication part 20 is hidden by the indication covering part 30, and the exposed state corresponds to a second state in which at least a portion of the quality indication part 20 is exposed.

The reversible garment 1 is a garment configured to be used with either surface facing outward. That is, both a first surface 11 and a second surface 12 can be used by turning the reversible garment 1 inside out as shown in FIGS. 1 and 2. Here, it is assumed that the first surface 11 is an outer surface, and the second surface 12, which is a surface opposite to the first surface 11 (that is, an opposite surface), is an inner surface.

As shown in FIGS. 3A and 3B, the reversible garment 1 includes a quality indication part 20 and an indication covering part 30. Here, the quality indication part 20 and the indication covering part 30 are provided on the second surface 12 of the reversible garment 1.

The quality indication part 20 indicates quality information 22 on the quality of the reversible garment 1. The quality information includes care instructions, fiber composition information, a name of a labeling party, and the like of the reversible garment 1, for example. In FIG. 3B, for convenience of explanation, the quality information 22 is simplified as “ΔΔΔ.” The quality indication part 20 is provided in order to prevent misunderstanding between a user and the manufacturer regarding the characteristics and handling of the reversible garment 1, as well as to protect the user from potential problems.

Here, the quality indication part 20 is a quality labeling tag (a first tag) attached to the second surface 12. One end of the quality indication part 20 in the longitudinal direction is sewn onto a seam 12a of the reversible garment 1 (for example, a seam between a front body and a back body of the reversible garment 1). The other end 21a of the quality indication part 20 in the longitudinal direction is a free end that is not fixed to the second surface 12. It should be noted that the quality indication part 20 is made of polyester, cotton, or rayon, for example. The one end of the quality indication part 20 in the longitudinal direction has been described to be sewn in the above, but it is not limited thereto. For example, the quality indication part 20 may be attached in a folded state, either sandwiching the reversible garment 1 or being attached to a seam.

The indication covering part 30 is provided so as to cover the quality indication part 20. The indication covering part 30 is larger than the quality indication part 20 and covers the entire quality indication part 20. The indication covering part 30 is attached to the seam 12a of the reversible garment 1 in the same manner as the quality indication part 20. Specifically, one end of the indication covering part 30 in the longitudinal direction is sewn onto the seam 12a. The indication covering part 30 retains its covering of the quality indication part 20 unless it is deformed by an external force. Therefore, the quality indication part 20 is normally in the covered state.

The indication covering part 30 indicates information other than the quality information (hereinafter, also referred to as additional information). Here, the indication covering part 30 is an identification labeling part that provides additional information, such as identification information 32 for identifying the origin of the reversible garment 1. The identification information is information indicating the origin of that product or the like to which the identification information is attached, for example, and more specifically, it may be a text or a logo mark indicating a brand name of the reversible garment 1. In FIG. 3A, for convenience of explanation, the identification information 32 is simplified as “hOOO.” The identification information 32 is desirably a logo mark or the like that is elaborate in design. This makes the indication covering part 30 to be a part of design, and even when the second surface 12 faces outward and the indication covering part 30 is exposed as shown in FIG. 2, the aesthetic design of the reversible garment 1 is not compromised.

It should be noted that the additional information has been described as the identification information 32 such as a logo mark in the above, but it is not limited thereto. The additional information may be a graphic element such as a crest or a national flag. Such a graphic element can be recognized as a decorative accent and is unlikely to compromise the aesthetic design of the reversible garment 1. In addition, the indication covering part 30 may be made of a solid-colored fabric (that is, plain) without any patterns or designs, for example.

For the user, there may be cases where they want to see the quality information 22 shown in the quality indication part 20 as needed. For example, the user may want to check the fiber composition of the reversible garment 1 and see the quality information 22 on the quality indication part 20. However, if the quality indication part 20 remains covered by the indication covering part 30, it may be difficult for the user to check the quality information 22.

Therefore, in the reversible garment 1 of the present embodiment, as will be described in detail later, at least one of the quality indication part 20 and the indication covering part 30 is deformable so that the transition between a covered state in which the quality indication part 20 is hidden by the indication covering part 30 and an exposed state in which at least a portion of the quality indication part 20 is exposed is available. Thus, the user can easily check the quality information of the reversible garment 1 by transitioning the quality indication part 20 to the exposed state. On the other hand, when the quality information is not being checked, the quality indication part 20 remains hidden and not exposed by retaining the covered state in which the indication covering part 30, which is a part of design, covers the quality indication part 20, thereby ensuring that the aesthetic design of the reversible garment 1, with the second surface 12 facing outward as shown in FIG. 2, is not compromised.

In the present embodiment, the quality indication part 20 and the indication covering part 30 constitute a quality indication member provided to an article having a first surface and a second surface opposite to the first surface. The quality indication member includes the aforementioned quality indication part 20 and indication covering part 30, allowing the quality information of the article to be easily recognized while suppressing any compromise to the aesthetic design of the article. It should be noted that an example of the article to which the quality indication member may be attached includes towels, handkerchiefs, Japanese wrapping cloth, bags, and tote bags. The article to which the quality indication member is attached may be reversible or non-reversible. For instance, the article to which the quality indication member is attached may have a fixed or interchangeable use for the first and second surfaces.

### Detailed Configuration of Quality Indication Part and Indication Covering Part

An example of a detailed configuration of the quality indication part 20 and the indication covering part 30 will be described with reference to FIGS. 3A and 3B.

The following describes an example in which the indication covering part 30, among the quality indication part 20 and the indication covering part 30, is configured to deform. Here, the indication covering part 30 is deformed with the second surface 12 of the reversible garment 1 faces outward as shown in FIG. 2.

The quality indication part 20 can transition between the covered state shown in FIG. 3A and the exposed state shown in FIG. 3B by deforming the indication covering part 30 so that its position relative to the quality indication part 20 shifts.

The indication covering part 30 is a stretchable elastic tag (a second tag) which is provided in an annular shape so as to sandwich both surfaces of the quality indication part 20 which is a quality labeling tag. One end 31a of the indication covering part 30 in the longitudinal direction is sewn onto the seam 12a of the reversible garment 1 in the same manner as the quality indication part 20, and the other end 31b in the longitudinal direction is a free end. Therefore, the indication covering part 30 can be stretched by pulling the other end 31b portion of the indication covering part 30 in the longitudinal direction.

For example, the user can put and move a finger F inside the other end 31b portion of the indication covering part 30 in the longitudinal direction to stretch the indication covering part 30, as shown in FIG. 3B. In this case, the user can stretch the indication covering part 30 at an angle downward or upward to expose the quality indication part 20 partially, as shown in FIG. 3B. On the other hand, when the user removes the finger F from the indication covering part 30, the indication covering part 30 is restored to its original shape and transitions to the covered state shown in FIG. 3A.

It should be noted that the indication covering part 30 is preferably stretchable, and the indication covering part 30 is made of polyester, cotton, or rayon, for example. In the above description, one end of the indication covering part 30 in the longitudinal direction is sewn, but it is not limited thereto. For example, the indication covering part 30 may be attached in a folded state, either sandwiching the reversible garment 1 or being attached to a seam.

As described above, the indication covering part 30, which is an elastic tag, stretches and shifts its position with respect to the quality indicating part 20, causing the quality indication part 20 to transition from the covered state to the exposed state. As a result, the user can transition the quality indication part 20 from the covered state to the exposed state by a simple operation, thus realizing a highly convenient configuration.

It should be noted that the user can shift the stretchable indication covering part 30 with respect to the quality indication part 20 to expose the quality indication part 20, but it is not limited thereto. For example, the quality indication part 20 may be exposed by the user shifting the quality indication part 20, configured to be stretchable, with respect to the indication covering part 30. In addition, when both the quality indication part 20 and the indication covering part 30 are stretchable, the user may shift the positions of both of the quality indication part 20 and the indication covering part 30 to transition the quality indication part 20 from the covered state to the exposed state.

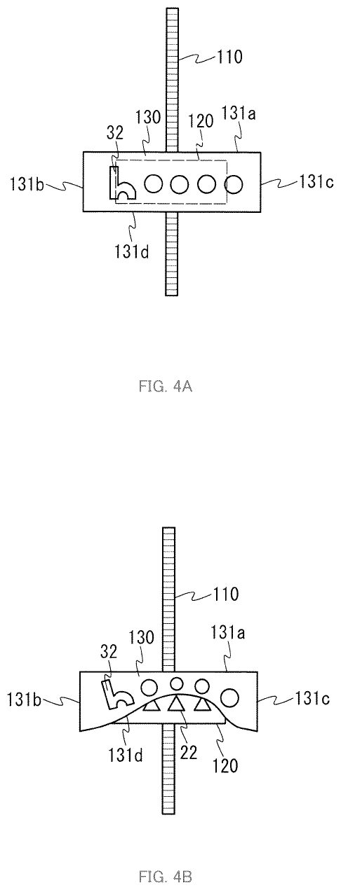

FIGS. 4A and 4B are schematic diagrams for explaining a quality indication part 120 and an indication covering part 130 according to a first modified example. FIG. 4A shows a covered state in which the quality indication part 120 is hidden by the indication covering part 130, and FIG. 4B shows an exposed state in which at least a portion of the quality indication part 120 is exposed.

In the above-described embodiment, as shown in FIG. 3B, the transition from the covered state to the exposed state of the quality indication part 20 is achieved by stretching the indication covering part 30 and shifting its position, but in the first modified example, the transition from the covered state to the exposed state of the quality indication part 120 is achieved by deforming the indication covering part 130 so as to fold back partially.

The indication covering part 130 here is a rectangular garment patch and is larger than the rectangular quality indication part 120. The indication covering part 130 covers the entire quality indication part 120 as shown in FIG. 4A, and the quality indication part 120 is not exposed in a normal state (FIG. 4A).

Further, the indication covering part 130 is fixed flat to the second surface 12 (see FIG. 4B) so as to fold back partially. Specifically, three edges 131a, 131b, and 131c, among four edges 131a, 131b, 131c and 131d, of the indication covering part 130 are sewn onto the second surface 12, and the remaining edge 131d is not sewn onto the second surface 12. The edge 131a is sewn on so as to span across the seam 110. The user can fold back the edge 131d that is not sewn on.

When the user wants to see the quality information 22 of the quality indication part 120, the user folds a portion (an edge 131d portion) of the indication covering part 130 as shown in FIG. 4B. This exposes at least a portion of the quality information 22 of the quality indication part 120. In this manner, in the first modified example, the transition from the covered state to the exposed state of the quality indication part 120 is achieved by folding back a portion (the edge 131d portion) of the indication covering part 130. Further, as the identification information 32 is shown on the indication covering part 130, the aesthetic design of the reversible garment 1 is not compromised even if the indication covering part 130 is exposed.

In the first modified example, the indication covering part 130 is a rectangular garment patch, but it is not limited thereto. For example, the indication covering part 130 may be an oval-shaped garment patch or a polygonal garment patch other than a rectangle.

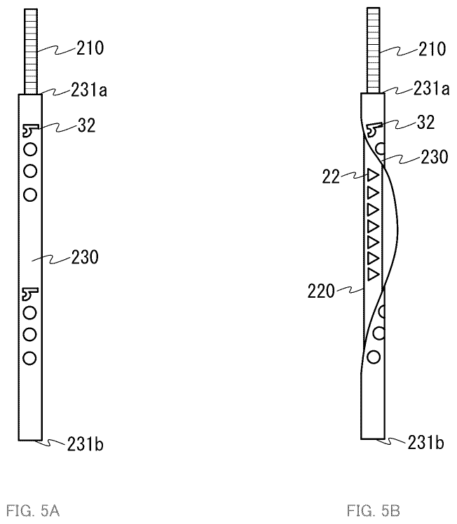

FIGS. 5A and 5B are schematic diagrams for explaining a quality indication part 220 and an indication covering part 230 according to a second modified example. FIG. 5A shows a covered state in which the quality indication part 220 is hidden by the indication covering part 230, and FIG. 5B shows an exposed state in which at least a portion of the quality indication part 220 is exposed.

As shown in FIG. 5B, the quality indication part 220 in the second modified example is printed on a seam 210 of the second surface 12 (FIG. 2). The indication covering part 230 is provided so as to cover the quality indication part 220 and the seam 210. Further, the indication covering part 230 is fixed to the second surface 12 so as to fold back partially. Specifically, both ends 231a and 231b of the indication covering part 230 in the longitudinal direction are sewn onto the second surface 12, and the center portion in the longitudinal direction can be folded back as shown in FIG. 5B. The indication covering part 230 is formed of a tape, for example.

When the user wants to see the quality information 22 of the quality indication part 220, the user folds back the center portion of the indication covering part 230 as shown in FIG. 5B. This exposes at least a portion of the quality information 22 of the quality indication part 220. In this manner, in the second modified example, the transition from the covered state to the exposed state of the quality indication part 220 is achieved by folding back the indication covering part 230 partially. In addition, as the identification information 32 is shown on the indication covering part 230, the aesthetic design of the reversible garment 1 is not compromised even if the indication covering part 230 is exposed.

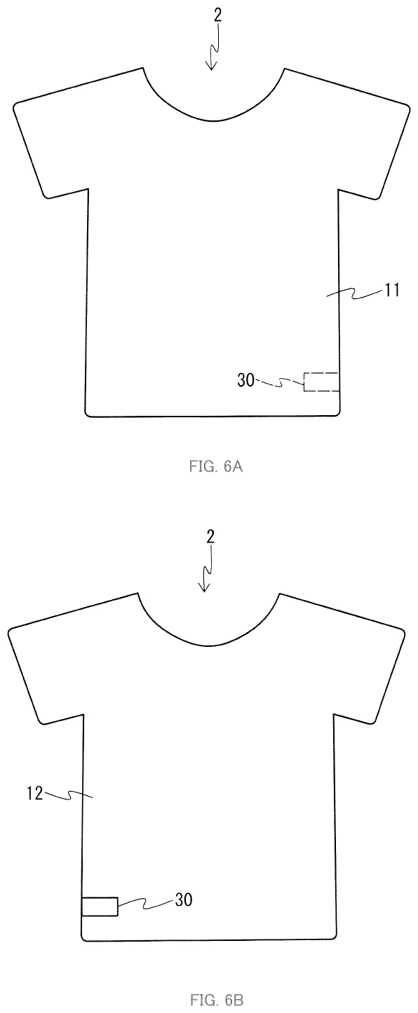

FIGS. 6A and 6B are schematic diagrams for explaining a modified example of a reversible garment 2. The reversible garment 1 shown in FIGS. 1 and 2 is a garment configured to be used with either surface facing outward. In contrast, the reversible garment 2 shown in FIGS. 6A and 6B are configured to be worn not only with its inner and outer surfaces reversed but also with its front and back reversed. In other words, the reversible garment 2 has no fixed front, back, inner, or outer surface. In the same manner as in the reversible garment 1, the quality indication part 20 and the indication covering part 30 are provided in the reversible garment 2, and the quality information 22 can be checked without compromising the aesthetic design.

In the above-described embodiment, the quality indication parts 20, 120, and 220 are transitioned to the exposed state by shifting the positions of the indication covering parts 30, 130, and 230 or folding them back, but it is not limited thereto. For example, a closable zipper may be provided to an indication covering part (here, the indication covering part 30 is used as an example), so that when the zipper is closed, the quality indication part 20 is in the covered state, and when the zipper is open, the quality indication part 20 is in the exposed state.

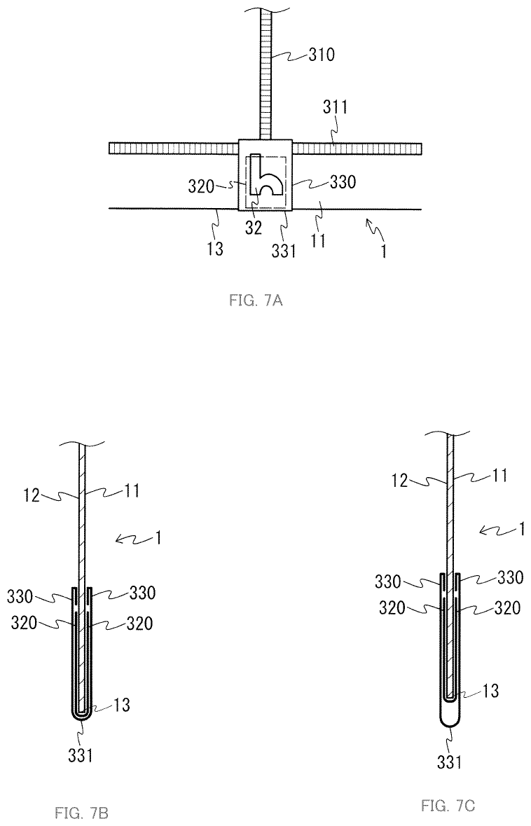

Further, in the above-described embodiment, the quality indication parts 20, 120, and 220 and the indication covering parts 30, 130, and 230 are provided only on the second surface 12, but it is not limited thereto. For example, the quality indication parts 20, 120, and 220 and the indication covering parts 30, 130, and 230 may be provided so as to span the second surface 12 and the first surface 11 (see FIG. 7).

FIGS. 7A to 7B are schematic diagrams for explaining a quality indication part 320 and an indication covering part 330 according to a third modified example. The quality indication part 320 and the indication covering part 330 according to the third modified example are provided at a lower portion of the side of the reversible garment 1 (specifically, at a lower portion of a seam 310 between the front body and the back body), as shown in FIG. 7A. Further, as shown in FIG. 7B, the quality indication part 320 and the indication covering part 330 are attached in a folded state at a hem 13 of the reversible garment 1, spanning both the first surface 11 and the second surface 12.

As shown in FIG. 7A, the identification information 32 of the indication covering part 330 is provided so as to be exposed not only on the first surface 11 of the reversible garment 1 but also on the second surface 12. As shown in FIGS. 7A and 7B, the quality indication part 320 is covered with the indication covering part 330. The quality information (the quality information 22 in FIG. 3B) of the quality indication part 320 is also located on the first surface 11 and the second surface 12 of the reversible garment 1.

As shown in FIG. 7C, the indication covering part 330 is configured to be stretchable, and the user can put and move his/her finger in a folded part 331 of the indication covering part 330 to shift the position of the indication covering part 330 or fold back the indication covering part 330. As the indication covering part 330 deforms in this way, the quality information on the quality indication part 320 is exposed, and the user can check the quality information.

### Effects of the Embodiment

In the garment described above (specifically, reversible garment 1), at least one of the quality indication part 20 and the indication covering part 30 is deformable so that the transition between the covered state (the first state) in which the quality indication part 20 is hidden by the indication covering part 30 and the exposed state (the second state) in which at least a portion of the quality indication part 20 is exposed is available.

Accordingly, for example, when the reversible garment 1 is used with the second surface 12 facing outward as shown in FIG. 2, the user can easily recognize the quality information of the reversible garment 1 by transitioning the quality indication part 20 to the exposed state. On the other hand, when the quality information is not being checked, the quality indication part 20 remains hidden and not exposed by retaining the covered state in which the indication covering part 30, which is a part of design, covers the quality indication part 20, thereby ensuring that the aesthetic design of the reversible garment 1, with the second surface 12 facing outward as shown in FIG. 2, is not compromised.

The garment according to the present disclosure is particularly significant when applied to the reversible garment 1. In a conventional reversible garment, it was difficult to adopt a measure that would make a quality label less conspicuous by placing it on the inner side of the garment. In contrast, the garment according to the present embodiment, even when it is the reversible garment 1, can avoid undermining the aesthetic design due to attachment of a quality label.

In addition, the garment according to the present disclosure can also be expected to improve the aesthetic design by covering the quality indication part 20 with the indication covering part 30 having a function as an identification labeling part.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

For example, it does not deviate from the present disclosure even if portion of the quality information is indicated in the indication covering part. As an example, it does not deviate from the present disclosure even if “polyester XX %,” “natural material,” and the like are indicated in the indication covering part.

What is claimed is:

1. A garment having a first surface and a second surface opposite the first surface, comprising:
a quality indication part that indicates quality information on quality of the garment and is provided on the second surface; and
an indication covering part that indicates information other than the quality information and is provided so as to cover the quality indication part; wherein
at least one of the quality indication part or the indication covering part is deformable so that transition between a first state in which the quality indication part is hidden by the indication covering part and a second state in which at least a portion of the quality indication part is exposed is available.

2. The garment according to claim 1, wherein
the garment is a reversible garment configured to allow both the first surface and the second surface to be used.

3. The garment according to claim 1, wherein
the indication covering part is an identification labeling part providing identification information for identifying the garment.

4. The garment according to claim 1, wherein
the quality indication part transitions from the first state to the second state by deforming the indication covering part so that a position of the indication covering part with respect to the quality indication part shifts.

5. The garment according to claim 1, wherein
when the indication covering part deforms so as to fold back partially, the quality indication part transitions from the first state to the second state.

6. The garment according to claim 1, wherein
the quality indication part is a first tag attached to the second surface,
the indication covering part is a stretchable second tag provided in an annular shape so as to sandwich both surfaces of the first tag, and
when the second tag is stretched and shifted in position, the quality indication part transitions from the first state to the second state.

7. The garment according to claim 1, wherein
the indication covering part is fixed flat to the second surface so as to fold back partially, and
when the indication covering part folds back partially, the quality indication part transitions from the first state to the second state.

8. The garment according to claim 1, wherein
the quality indication part is printed on a seam of the second surface,
the indication covering part is fixed so as to i) cover the quality indication part and the seam and ii) fold back partially, and
when the indication covering part folds back partially, the quality indication part transitions from the first state to the second state.

9. A quality indication member provided to an article having a first surface and a second surface opposite the first surface, comprising:
a quality indication part that indicates quality information on quality of the article and is provided on the second surface; and
an indication covering part that indicates information other than the quality information and is provided so as to cover the quality indication part; wherein
at least one of the quality indication part or the indication covering part is deformable so that transition between a first state in which the quality indication part is hidden by the indication covering part and a second state in which at least a portion of the quality indication part is exposed is available.

10. The garment according to claim 1, wherein
the quality indication part and the indication covering part are provided at a lower portion of the garment so as to span the first surface and the second surface.

11. The garment according to claim 10, wherein
the quality indication part and the indication covering part are provided at a lower portion of a seam between a front body and a back body of the garment.
